(19) United States
(12) Patent Application Publication
(10) Pub. No.: US 2022/0009028 A1
(43) Pub. Date: Jan. 13, 2022

(54) METHOD FOR FABRICATING NANOSTRUCTURED OPTICAL ELEMENTS USING POLARISED LIGHT

(71) Applicant: University of Southampton, Southampton, Hampshire (GB)

(72) Inventors: Peter KAZANSKY, Southampton, Hampshire (GB); Masaaki SAKAKURA, Cambridge, Cambridgeshire (GB); Lei WANG, Southampton, Hampshire (GB)

(21) Appl. No.: 17/297,102

(22) PCT Filed: Nov. 26, 2019
(86) PCT No.: PCT/GB2019/053327

§ 371 Date: May 26, 2021

(30) Foreign Application Priority Data
Nov. 26, 2018 (GB) 1819193.2

(51) Int. Cl. B23K 26/0622; B23K 26/073

(52) U.S. Cl. CPC B23K 26/0624; G02B 2207/101; B23K 26/0736

(57) ABSTRACT

A method of fabricating an optical element comprises providing a substrate of a transparent material; and applying one or more focused femtosecond pulses of laser light with an elliptical polarisation to a volume within the substrate to create at least one nanostructure in the volume.

### BACKGROUND OF THE INVENTION

The present invention relates to a method for fabricating nanostructured optical elements using polarised light.

A class of optical materials comprises transparent substrates internally structured with anisotropic nanopores that give birefringent properties to the material. This structure allows the materials to be used as elements for manipulating light via the geometric phase. Also known as the Panchatraman-Berry phase, this is a phase difference acquired by a wave, such as a light wave, over the course of a cycle. It occurs when both polarisation and phase are changed simultaneously but very slowly, and eventually brought back to an initial configuration. In other words, the light undergoes a cyclic adiabatic process. To achieve the geometric phase, the light wave is modified by transmission through an element with a nanoscale spatially varying anisotropy, to produce a phase difference or phase shift. Formation of such anisotropic sub-wavelength structures (nanostructures) was first reported in 1999 [1]. The nanostructure is formed by irradiating the substrate material, such as silica glass, with ultrashort pulses of laser light. More recently, this form of optical element has been proposed for data storage [2]. The individual nanopores have an anisotropic shape that gives a nanostructure comprising the nanopores an overall birefringence with an optical retardance value and slow axis of birefringence. Both the retardance and the slow axis can be controlled by setting properties of the laser pulses used to create the nanopores. Hence, by forming one or more nanostructures in a particular position using focused laser pulses, a data voxel with five degrees of freedom can be created: the three spatial dimensions corresponding to the voxel's position within the substrate, plus the retardance and slow axis values [3]. Data can be encoded by choosing values for these five properties, which offers a large data capacity, and the data accessibility is high because of the transparency of the substrate material. Significantly, data written in this way is expected to have an almost unlimited lifetime (estimated at longer than 10¹⁰ years at 462 K). Such so-called 5D, or multi-dimensional, optical data storage is therefore an attractive option for meeting the demands of modern data storage, which requires durability, high capacity, and ease of accessibility in order to accurately preserve extensive digital data far into the future.

In order for 5D data storage to become a widespread solution, the writing of the data should be via an efficient and accurate process. In particular, the speed of the data writing is of interest, and preferably should be as fast as possible while providing consistent quality. To achieve a high speed, the writing is performed by directing the focused laser pulses to each required voxel position by scanning or translating the beam of laser pulses relative to the substrate. Each voxel is written using multiple pulses to achieve a homogeneous birefringence at the vicinity of the laser focus [4]. In order to encode data, the nanopores at each voxel require independent birefringence properties compared to neighbouring voxels, so it is necessary to be able to modify the writing laser pulses for each voxel. This is technically challenging to achieve at with fast scanning, and hence presents an obstacle that limits maximum achievable data writing speeds.

Accordingly, techniques able to increase the speed of creating anisotropic nanopores in a substrate material are of interest.

### SUMMARY OF THE INVENTION

Aspects and embodiments of the invention are set out in the appended claims.

According to a first aspect of certain embodiments described herein, there is provided a method of fabricating an optical element comprising: providing a substrate of a transparent material; applying one or more focused femtosecond pulses of laser light with an elliptical polarisation to a volume within the substrate to create at least one nanostructure in the volume.

According to a second aspect of certain embodiments described herein, there is provided an optical element fabricated according to a method of the first aspect.

These and further aspects of certain embodiments are set out in the appended independent and dependent claims. It will be appreciated that features of the dependent claims may be combined with each other and features of the independent claims in combinations other than those explicitly set out in the claims. Furthermore, the approach described herein is not restricted to specific embodiments such as set out below, but includes and contemplates any appropriate combinations of features presented herein. For example, nanostructured optical elements and methods for fabricating such elements may be provided in accordance with approaches described herein which includes any one or more of the various features described below as appropriate.

### BRIEF DESCRIPTION OF THE DRAWINGS

For a better understanding of the invention and to show how the same may be carried into effect reference is now made by way of example to the accompanying drawings in which:

FIG. 1 shows a map of nanostructural modification type dependence on the energy and pulse duration of a writing light beam;

FIG. 2 shows a simplified schematic representation of an individual oblate anisotropic nanopore or nanostructure within a substrate;

FIG. 3A shows scanning electron microscope images of a type II nanograting structural modification in silica;

FIG. 3B shows scanning electron microscope images of a type X nanostructural modification in silica;

FIG. 3C shows scanning electron microscope images of a type X nanostructure and a type II nanograting;

FIG. 4 shows a birefringence image of discrete nanostructures of different birefringence formed in a substrate;

FIG. 5 shows a diagrammatic representation of elliptically polarised light with various parameters indicated;

FIG. 6 shows a simplified schematic representation of an example apparatus suitable for carrying out example methods described herein;

FIG. 7 shows a graph of the variation of retardance values for Type X nanostructures with the ellipticity of the laser pulses used to create the nanostructures;

FIG. 8 shows a birefringence image of nanostructures of different slow axis orientation created in a substrate using elliptically polarised laser pulses;

FIG. 9 shows a simplified schematic representation of an example polarising apparatus suitable for generating elliptically polarised laser pulses for use in methods described herein;

FIGS. 10A and 10B show respectively a map of the variation of laser pulse ellipticity with modulator retardance and a map of the variation of laser pulse azimuth with modulator retardance for a polarising apparatus for generating elliptically polarised light comprising two modulators;

FIG. 11 shows a graph of the variation of ellipticity with combined modulator retardance derived from the data of FIGS. 10A ands 10B;

FIG. 12 shows a flow chart of steps in an example of a method as described herein; and

FIG. 13 shows a graph of the variation of retardance values for Type II nanostructures with the ellipticity of the laser pulses used to create the nanostructures.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

Embodiments of the present disclosure relate to methods for fabricating nanostructured optical elements, for example elements for optically storing data and elements that use the geometric phase effect to modify the polarisation and/or phase of light. In the present disclosure, the term “optical element” refers to a substrate of appropriate material patterned with a nanostructure as described for optical use, regardless of the nature of the intended application, use or purpose of the nanostructured material. Such applications may or may not make use of the geometric phase or relate to data storage.

An alternative to conventional geometric phase devices such as those based on liquid crystal materials that offer better durability and uniformity is a nanostructure induced in a suitable material such as glass using an incident ultrashort (ultrafast) pulsed laser beam. An example of a geometrical phase element of this type is a radial/azimuthal polarisation converter or “S-waveplate”, described in WO 2015/150566 [5], which is able to transform incident linearly or circularly polarised light into radially/azimuthally polarised light or an optical vortex respectively. As noted in the Background section above, another significant use of such elements is for optical data storage. The nanostructure of the optical element comprises a collection of nanopores in a periodic or random distribution in an optically transparent material, such as silica. The nanopores are nanometre-scale structural modifications or changes in the bulk material. Although not yet well understood, the nanopores are likely to be voids created in the bulk material by the action of the incident laser pulses, and have a shape and orientation that depends on the optical properties of the laser pulses, and which confer the birefringent properties to the material.

Laser-induced writing processes for creating the nanostructures comprise scanning or writing an ultrashort pulsed focused laser beam over the material intended for the optical element. This is performed so as to deliver sufficient optical energy to the material to create a nanostructure of a particular type, where various types are described in more detail below. Some nanostructures have the form of nanogratings, in which an amount of optical energy is delivered which causes the nanopores to become self-organised into a periodic distribution that acts as an optical grating. In an early example of nanogratings [6], the formation of self-organised sub-wavelength periodic structures with feature sizes as small as 20 nm in bulk SiO₂ (silicon dioxide or silica) glass after irradiation with ultrashort light pulses from a Ti:sapphire laser was observed. Other examples of femtosecond laser-induced nanogratings in silica have also been reported [7]. Latterly, the phenomenon has been generalised to recognise different types of structural modification that can be induced by ultrafast laser irradiation of bulk optically transparent material, in particular silica glass. The type of structure is dependent in part on the parameters of the incident laser pulses. The structural modification is the presence of the nanopores, and is in effect a change in the material that alters its refractive index and provides a birefringence. Hence the optical properties of materials can be engineered by writing nanostructures into the material.

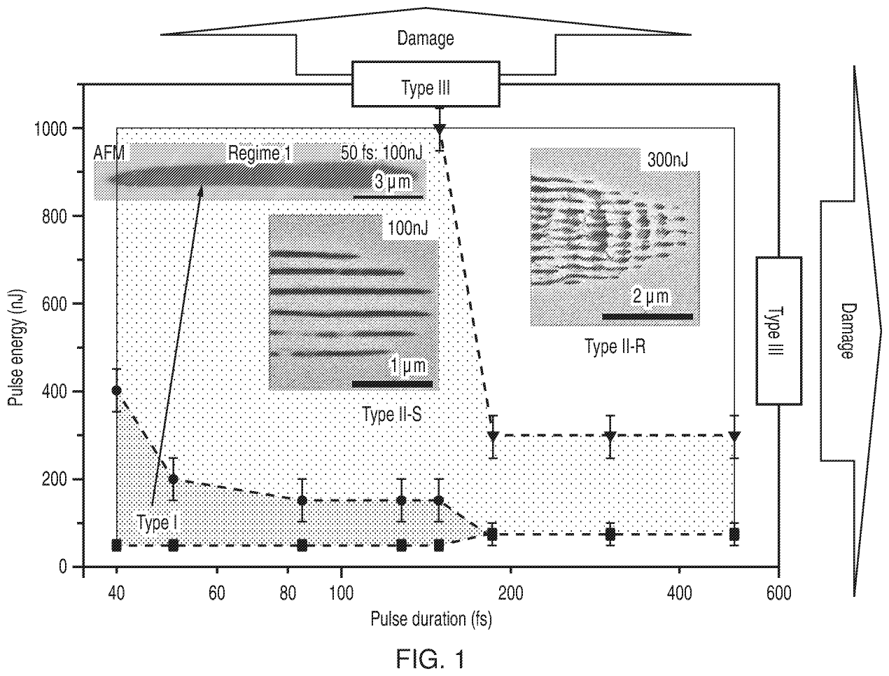

FIG. 1 [8] shows a plot of the relationship between laser pulse duration and pulse energy and the resulting structural change induced in a bulk transparent material, in this case fused silica. The pulsed laser beam is focused and directed at a location or moved or scanned along a path over the surface of a sample or blank of the material (a substrate) to induce the structural change in the volume of the material behind the area covered by the scan path and at the depth of the focus, at a rate that can be referred to a writing speed or scan speed. For a given pulse repetition rate, the speed of the writing determines the number of pulses delivered to any part of the material, referred to as the pulse density, in units of number of pulses per distance of path length. The total amount of energy delivered to the material then depends on the energy per pulse. A faster writing speed gives a lower pulse density and lower total energy for a given pulse energy, and a slower writing speed gives a higher pulse density and higher total energy for a given pulse energy. The data in FIG. 1 is obtained for a constant writing speed that is considered to be a slow writing speed, delivering a pulse density of more than 10⁶ pulses per millimetre of path length (pulse/mm). The laser emits femtosecond pulses, that is, pulses of duration up to about 1000 fs. Hence the structural modification induced by the energy of the incident laser pulses can be termed “femtosecond laser damage modification” (FLDM).

The type of structural modification, and the threshold of laser beam energy required to produce it, depends on factors including the laser parameters (pulse duration, pulse energy, pulse repetition rate, and wavelength), the numerical aperture of a lens or other focusing arrangement used to focus the beam onto surface of the material substrate, and the properties of the material itself (including band gap and thermal properties).

Three types of modification that have been defined are shown in FIG. 1: types I, II and III. These are described further below. In fused silica, the transition from type I to type II to type III is observed with an increase of pulse energy. Alternatively, type I may evolve into type II with an increased pulse duration or pulse density, if other parameters are constant. Hence, the total energy delivered by the pulses is relevant.

FIG. 1 shows that for shorter pulses and lower pulse energies, a type I modification is obtained, which is an isotropic, or smooth, refractive index change or modification, lacking birefringence owing to the absence of anisotropy. This is shown in the inset picture in FIG. 1 corresponding to the type I area, achieved using pulse energies between 50 and 100 nJ. At higher pulse energies and longer pulses, a type II modification is obtained, which is a form birefringence associated with nanogratings formed of self-assembled nanopores and a negative refractive index change. Type II modifications can be divided into two sub-types. Within the type II regime, lower energies and shorter pulses produce a type II-S (smooth) modification comprising nanogratings embedded in a smooth index modification. The type II-S area in FIG. 1 includes an inset picture of such a structure produced from 100 nJ pulses. Higher pulse energies and longer pulses produce a type II-R (rough) modification comprising a complex morphology of disrupted regions, nanogratings and smooth modification. The type II-R area in FIG. 1 includes an inset picture of such a structure produced from 300 nJ pulses.

In addition to type I and type II modifications, further increases in pulse energy and duration produce damage in the material; this is designated as a type III modification.

The formation of the various structural modification types is a competitive process, with a particular type dominating according to the processing conditions. Under certain processing conditions, type I can dominate over type II and III, or vice versa. Using short laser pulses, there is not enough energy deposited to the lattice of the bulk material to induce nanogratings or voids. Instead, random defects or nanostructures and local densification can be initiated which causes the positive index change. Alternatively, using extreme conditions such as high laser pulse repetition rates (typically in excess of 10 MHz), the laser pulses can provide sufficient accumulated heat and lattice thermalisation to induce permanent material modification. However, due to high fictive temperatures the structure has enough time to relax (erase) before the re-solidification takes place, resulting in densification and positive index change. Using low laser pulse repetition rates, longer laser pulses, high numerical aperture, or high pulse density, the threshold of energy from the laser pulses required for a type I modification overlaps with the energy threshold of type II or type III. In this case, the type II or III will dominate and the modification starts with the formation of nanogratings or damage, and the local temperature is low enough that the re-solidification takes place before the structure relaxes. Using very high energies, under any circumstances, the damage of type III is produced.

In summary, the type I structure has no optical anisotropy, the type II structure consists of nanogratings providing an anisotropic refractive index pattern and hence birefringence, where there is a strong dependence of the anisotropy on the polarisation of the writing beam, and the type III structure comprises damage with no polarisation-dependent anisotropy. A type II modification or structure behaves as a uniaxial birefringent material with an optical axis (slow axis of the birefringence) which is parallel to the direction of polarisation of the writing laser beam. The birefringence of the nanogratings is negative (for example, around −5×10⁻³ in silica). This is typical for lamellar-like form birefringence, and is of the same order of magnitude as the birefringence of quartz crystal (9×10⁻³). Consequently, these nanostructures are suitable for implementing geometric phase optics, as an alternative to conventional birefringent materials for phase manipulation of light. Type II nanogratings are self-assembled, meaning that individual nanopores or nanostructures making up the nanograting are arranged in a substantially regular and periodic placement or array. The self-assembly evolves with the number of pulses (pulse density) delivered to the irradiated region of the bulk material. The first pulses typically create randomly distributed nanostructures, with subsequent pulses enabling the modification to develop into a periodic lamellar-like nanograting.

Note that in the present disclosure, the term “nanostructure” may refer to individual structures (nanopores) within a nanograting (the nanograting is a collection of nanostructures or nanopores), or may refer to the overall structural modification making up a nanograting or other pattern of laser-induced structural modification (the nanograting is itself a nanostructure which is formed from nanopores). “Structure” and “nanostructure” may be used interchangeably, except if specifically indicated otherwise, or clear from the context. The term “nanostructure” indicates a structure with dimensions on the nanometre scale (i.e. 1000 nm or less, typically much less), which can also be considered as “sub-wavelength” structures in that the dimensions are smaller than the wavelength of light for which the optical element is designed. Each nanopore is an individual structural modification on the nanometre scale, in the form of a void in the bulk material that has a shape and orientation defined by the properties of the writing laser pulses.

A further type of structural modification can be designated as type X [9], which can have a reduced optical propagation loss compared to type II structures. Typically, a high pulse density delivered at a slow writing speed is used to minimise loss in type II structures since this allows an improved quality of the self-assembled nanostructure. Type X structures can be written using a contrary approach of reduced pulse density, for example delivered by increasing the writing speed (and hence a reduction in the total energy delivered to the material), and can show a significantly reduced loss compared to type II nanogratings. The writing technique delivers to the bulk material a density of femtosecond pulses that in many cases is lower than 10⁵ pulses/mm (100 pulses/μm). The resulting type X nanostructures show a relatively low birefringence, around four times less than the birefringence of type II nanogratings. Conventionally, a birefringence of this size might be dismissed as impractical for some applications. However, it has been found that by shaping the fast writing laser beam with a low numerical aperture lens for a correspondingly long Rayleigh length, the nanostructures can be written with a relatively long length in the intended optical propagation direction through the optical element. Lengths of the order of 50 μm or more, for example up to about 100 μm, can be written. This length of nanostructure, lying along the light propagation direction, compensates for the low birefringence, since the required parameter for birefringent operation is phase retardance, defined as the product of birefringence and optical path length. For 5D data storage, the retardance parameter can be readily varied to encode the data by adjustment of the lens to control the nanopore length, and adjustment of laser energy and pulse quantity to control the density of nanopores and the aspect ratio and volume of the individual nanopores.

A type X modification comprises randomly distributed individual nanopores or nanostructures, as would be expected in the absence of the high pulse density employed to form self-assembled regular type II structures. However, periodicity of the nanostructures is not required to provide the desired birefringence, which instead depends on the orientation of the individual structures within the bulk material. Hence, the absence of self-assembly is not a barrier to the production of high quality optical elements. Also, the type X anisotropy is controlled by the polarisation of the laser writing beam. Each nanopore has an anisotropy defined by its shape, which is an oblate spheroid (ellipsoid) shape, or lenticular shape. As noted, the nanopores are randomly spaced apart within the substrate material, although lying generally within a layer at a constant depth behind the optical input surface of the optical element. More than one layer may be written depending on the intended use of the optical element; 5D data storage may use multiple layers, for example, each being a layer of voxels in a 3D array, and the nanopores within each layer being grouped into separate voxels. Each voxel comprises a plurality of nanopores which may have substantially the same or a similar size, shape and orientation, and the average orientation of the nanopores in a voxel is determined by the polarisation orientation of the writing pulses. These properties vary between voxels in order to encode data via differences in the retardance and the slow axis. The oblate spheroid shape of each nanopore is oriented with the plane of its circular cross section parallel to the optical propagation direction through the optical element and perpendicular to the input surface of the optical element (the surface scanned by the writing beam). The elliptical or oval cross-section which is parallel to the input surface can be oriented with its major axis at any angle, where the major axis is formed perpendicular to the polarisation of the writing light beam. The minor axis is parallel to the polarisation of the writing light beam. Since the overall shape is lenticular, the extent of the nanostructure in the optical propagation direction, namely the length along the direction through the thickness of the optical element from the input surface to the output surface, may be the same as or similar to the major axis. The overall shape of the nanostructure is determined by the intensity distribution of the laser pulses near the focal point.

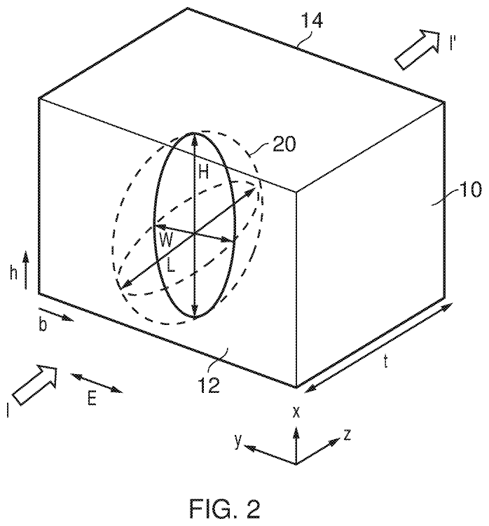

FIG. 2 shows a highly schematic and not-to-scale representation of an individual nanopore 20 within an optical element 10. For clarity, just a single nanopore is shown, but as described above, in reality the nanostructural modification comprises many such nanopores arranged within the material of the optical element, randomly for a Type X modification and periodically for a Type II modification. The optical element 10 has an input face 12 for receiving incident light, which propagates through the optical element along a propagation direction z which is parallel to the thickness t of the optical element and leaves through an output face 14 opposite to the input face 12. For the initial writing, the incident light beam I has a polarisation E which in this example is linear and aligned parallel to the y direction, or breadth of the sample forming the optical element 10. In use of the formed optical element, an incident or input light beam I is modified or transformed into output light beam I′ by the birefringence of the optical element 10 created by the writing process, or used to read data encoded by the nanopores. The nanopore 20 has a length L substantially parallel to the thickness t of the optical element, which is typically not greater than 100 nm. The length L is perpendicular to the plane of the input face 12. The nanopore 20 has a cross-sectional shape in a plane parallel to the input face which has an oval, elliptical or oblate shape, with a major axis or height H and a smaller minor axis or width W orthogonal to the height. The major axis is larger than the minor axis. The width W has a size not larger than about 30 nm, typically. Owing to the oblate spheroidal shape of the nanopore 20, the length L and the height H may be substantially equal so that the cross-section of the nanopore 20 through the length L and height H may be roughly circular. In some cases there may be some small or more significant difference between the length L and height H, since the growth of the nanopore during the writing process along these two dimensions may evolve differently. For example, the length L may become greater than the height H. Typically, though, L and H will be at least similar to each other when compared to the width W, which is less than both. The input face 12 has a height dimension h and an orthogonal breadth direction b. The width W and height H of the nanostructure 20 lie at some angle to the height h and the breadth b; this sets the orientation of the nanopore which is defined as lying along the height direction (major axis). Either of H and W can be parallel to either of h or b, or can be arranged at any angle between the parallel alignment. This orientation (direction of the major axis H) is the direction (azimuth) of the slow axis of the birefringence offered by the nanostructure comprising the nanopore. The orientation is set by the polarisation E of the incident light beam, where W is parallel to E and H is perpendicular to E. Hence, rotation of the polarisation direction of the writing light beam controls the slow axis direction of the generated birefringence. The length L of the nanopore 20, being the dimension along the optical propagation direction, partly determines the total retardance available from the birefringence, and can be varied by controlling the amount of optical energy applied to form the nanopores. The contribution of the nanopore shape to the retardance varies by nanopore volume and the ratio between W and H. The overall total retardance depends also on the density of the nanopores and the length of the region or volume containing the nanopores. The total energy can be modified by changing parameters including the pulse duration, individual pulse energy, pulse repetition rate, number of pulses and numerical aperture of the pulse focusing. Hence, both the retardance and the slow axis orientation of the birefringence provided by a nanostructure can be readily controlled.

Type X can be thought of an intermediate type of structural modification, having a random distribution of nanostructures which nevertheless has a strong polarisation-dependent anisotropy. Visually, a type X structure has the appearance of a type I modification (with high transmission and therefore not readily apparent to visual inspection) combined with the behaviour of a type II modification (strong anisotropy).

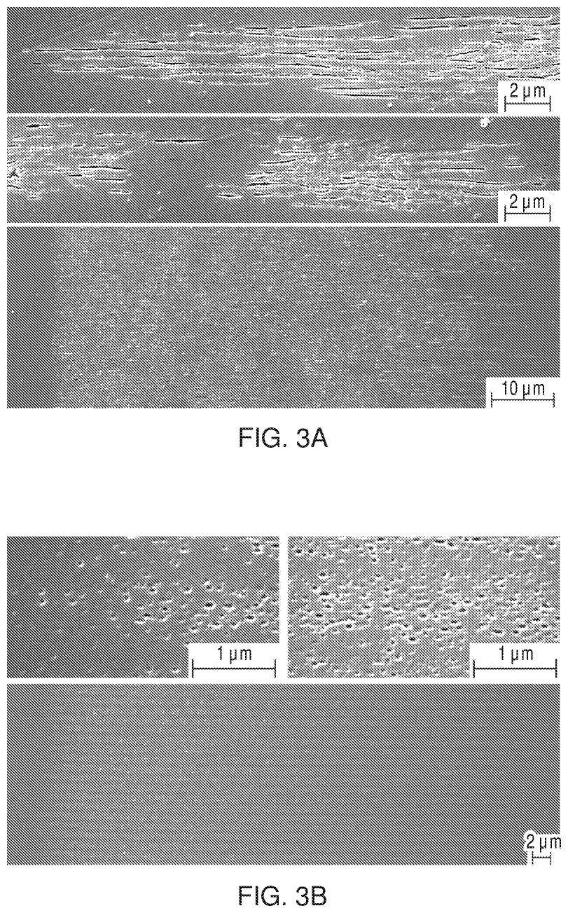

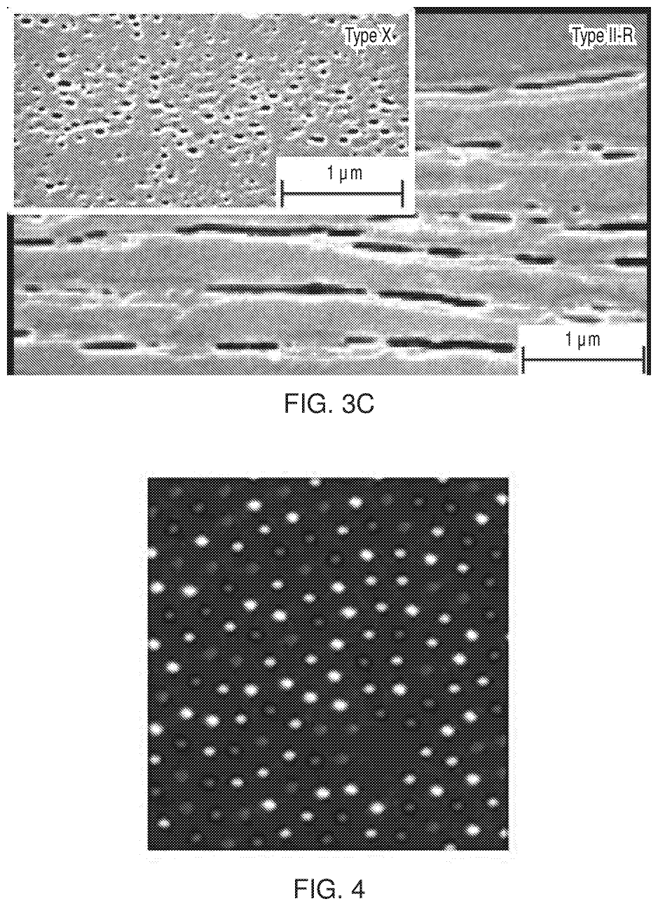

FIGS. 3A, 3B and 3C show scanning electron microscope (SEM) images of examples of structural modifications written into bulk silica. FIG. 3A shows three images of cross-sections through silica (of which two are “close-up” images and one is a wider angle view, as indicated by the scales shown) having a type II-R modification written with a pulse density of >10⁵ pulses/mm. The regular, periodic arrangement of the lamellar-like structures making up the nanograting is readily apparent. FIG. 3B, in contrast, shows three images (again at different scales, as indicated) of cross-sections through an element into which a type X modification has been written using a pulse density of <10⁵ pulses/mm. The random distribution of the nanopores and the oval cross-sectional shape can be seen. For ease of comparison, FIG. 3C shows an image of a type X modification and an image of a type II-R modification at the same magnification, from which the different shapes and arrangements of the two modification types can be readily appreciated.

Note that in the present disclosure, the term “random” is used to describe that the nanostructures or nanopores in a type X modification are arranged without any discernible periodicity or pattern. The spacing between adjacent nanostructures or nanopores is random, and the individual nanopores are positioned at random in a layer within the thickness of the bulk material.

FIG. 4 shows a birefringence image of a further type X modification, comprising a plurality of dots written inside silica. Each dot comprises a plurality of nanopores (so each dot might be considered as a nanostructure, for example), and may make up an individual voxel in a data storage element, for example. The different brightnesses of the dots arises from the different slow axes offered by the different nanostructures, and the different diameters of the dots indicates different values of retardance. Each dot is written separately by applying ultrashort pulses of polarised laser light focused to the desired location in the silica substrate. The orientation of the slow axis of the birefringence is set by the orientation of the polarisation, and the magnitude of the retardance is set by the total number of pulses and the energy per pulse, combining to give a total optical energy delivered at that location.

For both type II structures and type X structures, it is typical to apply a multiplicity of ultrashort laser pulses to the substrate material, in order to create a consistent and uniform birefringence. For example, about 10 or 50 or 100 pulses or more might be used. Importantly, in existing techniques, the laser light is linearly polarised, where a defined polarisation direction is required in order to shape the nanopores into an oblate spheroidal shape, to achieve the anisotropy that produces the desired birefringence. The linearly polarised light has an anisotropic electric field distribution which is enhanced at the equators of the initially spherical nanopores induced in the substrate material by the laser pulses and causes the spheres to grow into oblate shapes with a longer dimension oriented perpendicular to the polarisation direction of the laser light. In summary, therefore, writing nanopores of a particular birefringence into a substrate requires ultrashort laser pulses with a polarisation direction or orientation which is selected to define the slow axis orientation of the birefringence, and an amount of optical energy which is selected to define the level of retardance of the birefringence. For rapid fabrication of optical elements in which there is a requirement for the birefringent properties to be varied on a small scale, for example the writing of individual voxels in a data storage element, it is necessary to be able to modify the laser pulse properties quickly and accurately.

To date, nanostructure writing has been carried out using linearly polarised light to define the birefringence slow axis orientation. In order to provide a full range of orientations, the polarisation orientation needs to be varied from 0° to 180°, and this requires a large range of retardance from the polarising element used to produce the linear polarisation state. An electro-optic modulator is typically used as the polarising element, and requires a large range of applied voltage, such as up to several kilovolts, in order to provide the retardance range. It is technically challenging to switch the voltage to vary the slow axis orientation between voxels when writing at a high speed. At the same time, there is a requirement to vary the pulse energy or pulse density in synchronism with the voltage switching in order to write the birefringence retardance value needed for each voxel.

The present disclosure proposes instead to use elliptically polarised light to write nanostructures into substrate materials. It has been found that the orientation of an elliptical polarisation acts in the same way as the orientation of linear polarisation to define the slow axis orientation of the birefringent nanostructure. Hence, elliptically polarised light can straightforwardly replace linearly polarised light. Additionally, however, it has been found that retardance of the birefringent nanostructure depends on the ellipticity of elliptically polarised light, so this property can be used to control the retardance when writing the nanostructure. Hence, there is no need to adjust the amount of optical power in order to achieve a particular retardance. A constant pulse power (and writing speed, and pulse repetition rate, and other factors that determine the total amount of power delivered) can be used throughout the fabrication of all nanostructures in a substrate, and only the polarisation characteristics need be varied. Hence, the writing process is simplified. Furthermore, the necessary voltage switching to control polarising elements such as electro-optic modulators can be simplified compared to the management of linear polarisations since lower voltages can be employed to achieve an equivalent range of control, which enables faster switching.

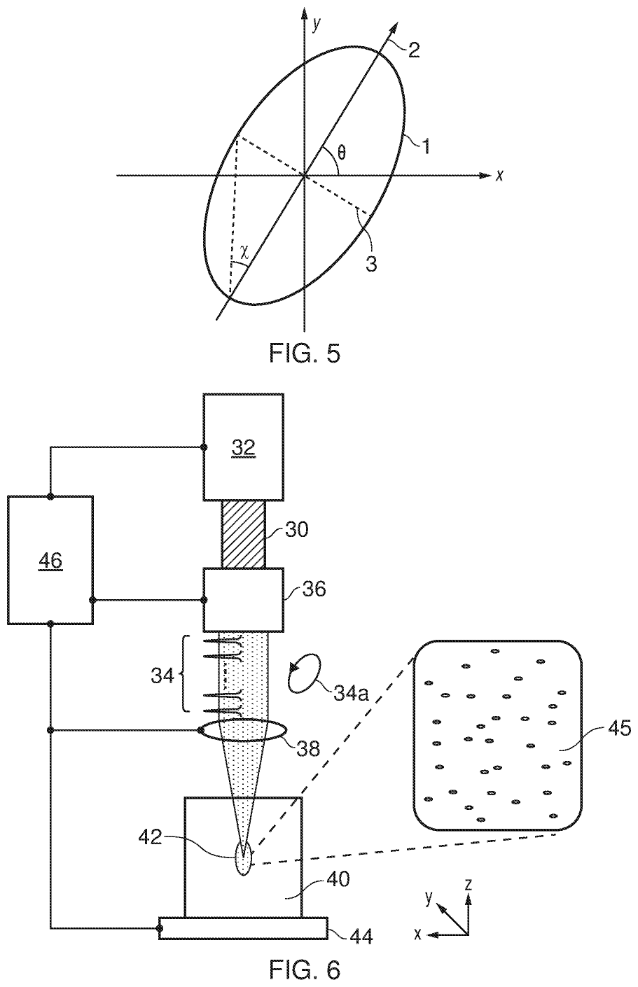

FIG. 5 shows a diagram of an ellipse describing elliptically polarised light, in order to explain relevant parameters. The light propagates in the z-direction, into the page, and the elliptical polarisation lies in the x-y plane perpendicular to the propagation direction, namely the plane of the page. The ellipse 1 indicates the trajectory of the electric vector of the elliptically polarised light. In the conventional manner, the ellipse has a major (long) axis 2, and a minor (short) axis 3. The major axis 2 is designated as the polarisation axis, or the direction or orientation of the polarisation. The major axis 2 lies at an angle θ to the x-axis, and this angle is designated as the azimuth of the major axis, in order to describe the polarisation orientation. When creating an anisotropic (oblate spheroidal) nanopore, the larger dimension H (see FIG. 2) of the oblate spheroidal nanopore forms perpendicularly to the polarisation orientation (major axis direction in the case of elliptical polarisation) of the writing light pulses. The dimension H defines the slow axis of the birefringence of the nanostructure, so the birefringence slow axis is perpendicular to the writing pulse polarisation direction. Hence, the slow axis orientation of written nanostructures can be set by adjusting the polarisation direction of the writing pulse or pulses. This is applicable for creating Type X nanostructures, but elliptical polarisations can also be used to achieve Type II nanostructures.

The ellipse 1 is also described by an angle χ, which is the angle between the major axis 2 and a line connecting the intersection of the major axis with the ellipse boundary and the intersection of the minor axis with the ellipse boundary. This angle specifies the ellipticity of the ellipse, which is defined as tan (χ). A value of 1 for the ellipticity indicates that the ellipse is actually a circle, so the light is circularly polarised. A value of 0 for the ellipticity indicates that the ellipse has been reduced to a line, so the light is linearly polarised. Values greater than 0 indicate non-linearly polarised light. Values up to 1 indicate elliptically polarised light, where a value of 1 is a circular polarisation and a circle might be considered as a special case of an ellipse. However, circularly polarised light pulses produce isotropically shaped substantially spherical nanopores which do not provide any birefringence. Hence, circularly polarised light cannot be used to create birefringent nanostructures. Typically, then, if the ellipticity is designated as “e”, in order to create birefringent nanostructures in accordance with presently-disclosed methods, the light pulses have an elliptical polarisation in the range 0<e<1. However, it may be useful in some cases to include the option of accessing a circular polarisation in order to avoid birefringence, for example if a particular region in a substrate is required to lack birefringence. It may be preferred to switch the writing light pulses to an e=1 condition and continue the writing process over this region, than to interrupt the supply of light pulses to prevent writing altogether. Therefore, in some embodiments, the light pulses have an elliptical polarisation in the range 0<e≤1. Smaller sub-ranges for the ellipticity are also of interest, as discussed in more detail below.

FIG. 6 shows a schematic representation of an example apparatus suitable for implementing a method of writing nanopores into a substrate using elliptically polarised light pulses. An optical source 32 is operable to generate a beam of laser light 30 in the form of ultrashort femtosecond-duration pulses 34. The beam 30 is passed through a polarising apparatus, element or device 36 (examples of which will be described in more detail later) in order to assign an elliptical polarisation 34a to the laser light. The polarising apparatus 36 is controllable in order to modify the polarisation characteristics, and the azimuth and ellipticity of the polarisation state are selected with reference to the desired slow axis orientation and retardance of the region where the laser light is focused. The elliptically polarised pulses 34 are passed through a lens 38 or other focusing element or elements which brings the beam to a focus at a focal point 42 which is positioned within a substrate 40 of transparent material. The pulses deliver optical energy to the material of the substrate in the volume of the focal point or region 42, and create nanostructures within this volume in the known manner, comprising randomly arranged anisotropic nanopores for Type X or a periodic nanostructure or nanograting for Type II. The inset in FIG. 6 shows, as an example, oblate nanopores 45 of a Type X modification. In order to form nanostructures throughout the substrate 40, either continuously or at discrete locations, (for example, spaced-apart voxels in a data storage element), the substrate 40 may be mounted on a translation stage 44 or similar arrangement operable to move the substrate in the x-y plane relative to the beam 30, so that the beam can travel along a writing path to create nanostructures where required. The lens 38 may be adjusted to change the location of the focal point 42 along the beam propagation direction (z direction) so that nanostructures can be formed at different depths within the substrate 40. The numerical aperture of the lens 38 is selected to achieve a focal region of appropriate depth, having regard to optical power density required at the focus to create the nanostructures, and the desired extent of the volume to be populated with nanopores or other nanostructures. An example value for the numerical aperture is 0.16. Each of the polarising apparatus 36, the translation stage 44, the lens 38 and the optical source 32 can be under the control of a controller 46 (which may be a processor programmed with suitable software, or electronic hardware configured to provide an equivalent function, or a combination of the software and hardware) operable to deliver a required number of femtosecond pulses 34 at a particular pulse energy, repetition rate, wavelength, and having a selected elliptical polarisation azimuth and ellipticity, to a volume within the substrate 40 at one or more required locations.

The number of pulses delivered to a given volume can be selected with reference to the total amount of energy required to create the nanostructure of interest. Typically, about ten or more pulses, such as 20, 50, 100 or 200 can be used to achieve a uniform birefringence. However, fewer pulses might be adequate, and in some circumstances the elliptically polarised pulses can be applied to develop anisotropic oblate spheroidal nanopores from pre-formed isotropic spherical nanopores (made using circularly polarised light pulses, for example) already present in a substrate. In such a case, one single elliptically polarised pulse might be adequate, or a number of pulses between two and ten inclusive. Accordingly, embodiments of the presently described method are intended to cover the delivery of any number of elliptically polarised light pulses to a substrate, including one single pulse and all numbers of pulses in excess of one. The pulse energy and other pulse characteristics can be kept constant for all volumes in a substrate; this simplifies the writing process.

As mentioned above, while the orientation of the elliptical polarisation (azimuth) determines the slow axis orientation of the birefringence provided by the nanostructure, the retardance of the birefringence depends on the ellipticity of the elliptical polarisation. Accordingly, this parameter can be set simply by controlling the ellipticity of the laser pulses throughout the process of writing a substrate. The retardance is the magnitude of the birefringence provided by a nanostructure (or any other birefringent structure, element or device). Under previous nanostructure writing techniques, the value of the retardance has typically been controlled by providing a smaller or greater total optical energy amount.

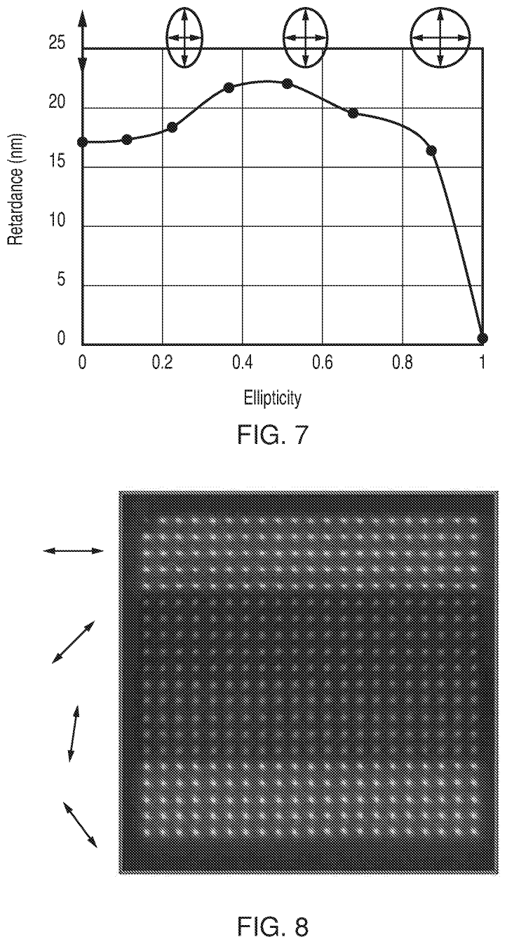

FIG. 7 shows a graph of the dependence of retardance on ellipticity as determined by experiment. Ellipticity ranges from 0, corresponding to linear polarisation, to 1, corresponding to circularly polarisation, as discussed above with regard to FIG. 5. To obtain the data of FIG. 7, five elliptically polarised pulses were applied to a silica substrate which had been previously prepared with isotropic spherical nanopores by the application of 150 pulses of circularly polarised light in the manner noted above, to form anisotropic nanopores for a Type X modification. The energy per pulse was 0.9 μJ. However, the results are generally applicable, and retardance control by selection of ellipticity is obtained also for methods using elliptical polarisation only, and methods using other numbers of circularly polarised pulses followed by elliptically polarised pulses.

The graph of FIG. 7 shows how the retardance varies across the full range of ellipticity, 0≤e≤1. From this it is clear that significant changes in the value of the retardance are produced by altering the ellipticity. Accordingly, the amount of birefringence of a nanostructure can be controlled by the ellipticity of the polarised light pulses used to create the nanopores. An important point to note is that linear polarisation, e=0, produced (in this example) a retardance of 17 nm, whereas significantly larger levels of retardance, up to about 22 nm, were produced by larger ellipticity values, between about 0.3 and 0.7. Accordingly, it is deduced that linear polarisation is not only not necessary to create oblate spheroidal nanopores, it is also not the most effective polarisation for generating large birefringence levels.

A further important point is that the whole range of achievable retardance, from the maximum (in this case about 22 nm) down to zero, can be accessed over an ellipticity range of 0.5≤e≤1.0, in other words, only half of the total ellipticity range. Hence, there is no requirement to provide switching or other variability of the ellipticity of the polarised light pulses over the full range from linear to circular. The lower half of the ellipticity range, for e<0.5, corresponds to retardance values that can also be obtained for values of e>0.5, so can be considered redundant. Accordingly, in embodiments, the writing of a substrate can be carried out by controlling ellipticity of the elliptically polarised light pulses over the range of 0.5≤e≤1.0. Apparatus for performing the writing can be configured to be operable to control the ellipticity of the elliptically polarised light pulses over the range of 0.5≤e≤1.0. This approach can provide faster writing speeds because the ellipticity can be adjusted more rapidly over the required range if that range is smaller.

FIG. 8 shows a birefringence image of a silica substrate into which nanostructures have been written using elliptically polarised light. The nanostructures are regularly spaced apart at discrete locations or volumes through the substrate, corresponding to an arrangement that might be used to provide voxels in an optical data storage element. Each nanostructured volume appears as a bright spot, indicating that a significant birefringence has been created. The retardance is the same for each location, since the ellipticity was not varied between the voxels, and was measured to be about 7 nm. However, it will be observed that the spots are in four groups, of different apparent brightness. This reflects different colours in the original birefringence image, corresponding to different orientations of the birefringence slow axis for each group. The slow axis orientation is indicated at the left side of the image, and was controlled during writing by changing the azimuth or orientation of the polarisation axis of the writing pulses for the different voxel groups.

The polarisation state (azimuth and ellipticity) of the polarised femtosecond light pulses can be set in any desired manner, using any suitable apparatus. Preferably, it is possible to control the polarising apparatus in order to independently set both the azimuth and the ellipticity at a suitably high rate for the intended speed of writing nanostructures into a substrate, so the birefringence properties can be controlled for all volumes throughout a substrate. In more simple cases, it may be sufficient that only one or other of the azimuth and ellipticity are adjustable, if it is only intended that nanostructures in a substrate vary in slow axis angle or in retardance, but not in both. Most simply, there may be no requirement for adjustability if large quantities of nanostructures with the same birefringence characteristics are to be made, in which case the azimuth and ellipticity can be kept constant.

For maximum flexibility, however, independent control of the ellipticity and the azimuth are desirable. This can be achieved by use of a so-called “universal retarder” polarising apparatus, which is a collection of optical, electro-optical and/or acousto-optical elements and devices able to generate any state of polarisation from linear through elliptical to circular, and with any azimuthal orientation.

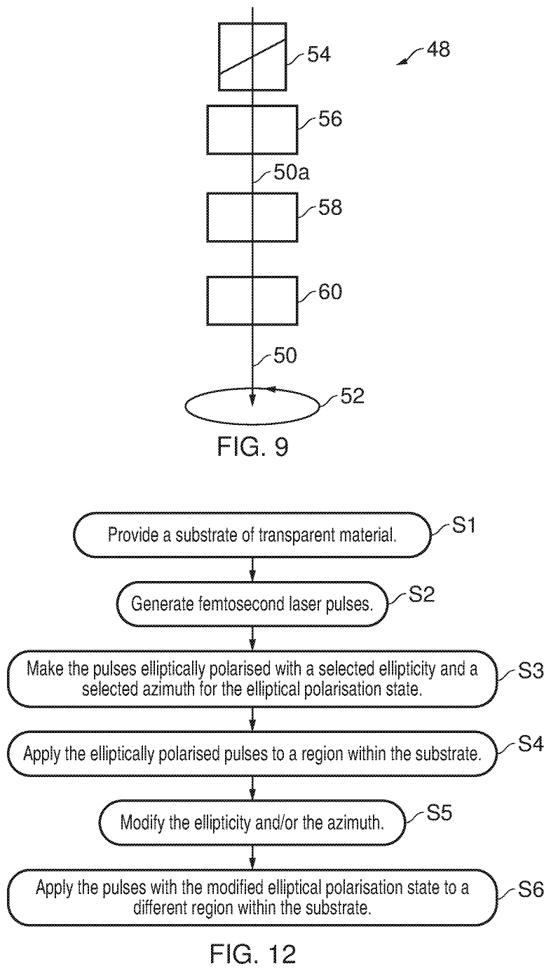

FIG. 9 shows a highly schematic representation of an example polarising apparatus of this type. A light beam 50 passes through the apparatus 48 to acquire an elliptical polarisation state 52. The apparatus comprises firstly a linear polariser 54 orientated at 0°, followed by a quarter waveplate 56 with its slow axis oriented at 45° to the linear polariser 54. These elements have the combined effect of giving the light beam 52 a circular polarisation state, so that at location 50a the beam is circularly polarised. Then a pair of optical modulators are provided which receive the circularly polarised light. A first optical modulator 58 is arranged with its axis at the 0° orientation, and has a retardance value Δ1. It operates to produce elliptically polarised light with its major axis (azimuth) oriented at 45° to the axis of the first optical modulator 58. A second optical modulator 60 receives this light from the first optical modulator 58. The second optical modulator 60 has its axis at 45° to the axis of the first optical modulator 58, and has a retardance value Δ2 The effect of the second optical modulator 60 is to select both the ellipticity and the major axis orientation of the already-elliptically polarised light from the first optical modulator. The two optical modulators are in effect a pair of arbitrary retarders whose cumulative effect is to produce an elliptical polarisation state.

In an example, the first optical modulator 58 and the second optical modulator 60 may each be an electro-optic modulator, such as a Pockel's cell (other types of electro-optic modulator may alternatively be used). The retardance Δ of an electro-optic modulator is controlled by the application of a voltage. Accordingly, control of voltages applied to the first optical modulator 58 and the second optical modulator 60 provides the ability to set any desired azimuth and ellipticity values for the light pulses required to write nanostructures into a substrate. An advantage of electro-optic modulators is that no mechanical movement occurs in the polarising apparatus to produce the azimuth and ellipticity control. Other configurations of universal retarder can require mechanical movement of components such as halfwave plates in order to adjust the ellipticity and the azimuth. Alternatively, the optical modulators may comprise acousto-optic modulators or liquid crystal cells.

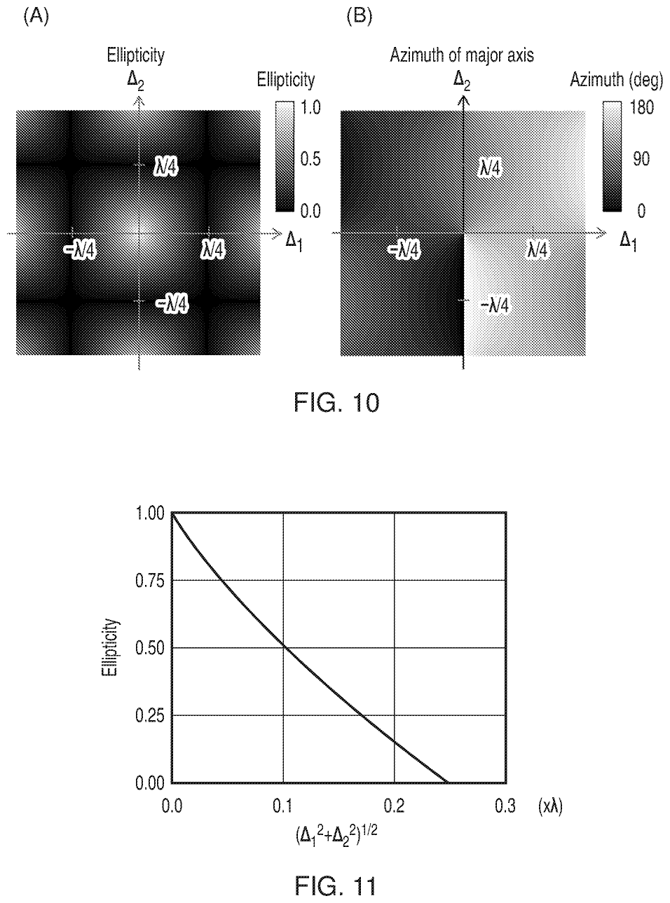

FIG. 10 shows maps or contour plots of the variation of ellipticity and azimuth of the final elliptically polarised light that can be produced by varying the retardance values Δ1 and Δ2 of the two optical modulators. FIG. 10A shows a map for the variation of ellipticity, across the full possible range of 0 to 1, for positive and negative values of Δ1 and Δ2. From this it can be appreciated that any value of ellipticity can be accessed by selecting values of Δ1 and Δ2 between −λ/4 and +λ/4, where A is the wavelength of the laser beam pulses. FIG. 10B shows a map for the variation of azimuth of the major axis (polarisation orientation), across the full possible range of 0° to 180°, for positive and negative values of Δ1 and Δ2. Again, it can be appreciated that any value of azimuth can be accessed by selecting values of Δ1 and Δ2 between −λ/4 and +λ/4. In the case of electro-optic modulators, the applied voltages for the first and second optical modulators can be set accordingly to provide the values of modulator retardance that create the desired azimuth and ellipticity values.

FIG. 11 shows a graph of the variation of ellipticity with the combined modulator retardances, calculated as the square root of the sum of the squares, (Δ1²+Δ2²)^{1/2}. In agreement with the FIG. 10 maps, the graph shows that the full range of ellipticity from 0 to 1 can be accessed from retardance values between 0 and 0.25λ, or λ/4 (corresponding to the −λ/4 to +λ/4 range noted above). However, recall from FIG. 7 that the full range of available birefringence retardance from the minimum of zero to the maximum of the nanostructure can be accessed using ellipticity values in the range of 0.5≤e≤1 only. Referring to FIG. 11, it can be seen that this ellipticity range corresponds to modulator retardance values in the range of 0 to 0.1λ. Accordingly, Δ1 and Δ2 can be controlled between only −0.1λ and +0.1λ (−λ/10 and +λ/10) to provide all the required values of ellipticity. This range of Δ1 and Δ2 still provides the full range of azimuths (see FIG. 10A). Therefore, it is possible to operate methods as described herein by controlling modulators in a polarising apparatus to have retardances over the range of −0.1λ to +0.1λ only.

In contrast, in conventional techniques using linearly polarised laser pulses to create nanopores, a single retarder device is used which requires its retardance value to be modifiable across the range of −λ/2 to λ/2 (or 0 to 0.5λ) in order to change the azimuth angle (polarisation orientation) of the linearly polarised light between 0° and 180°. Therefore, using embodiments of the method proposed herein, the required range of modulator retardance (−0.1λ to +0.1λ, or 0.2λ) is 5 times smaller than the conventional range (−0.5λ to 0.5λ, or 1.0λ).

To implement this much smaller range of modulator retardance, much lower voltage ranges are required for the two electro-optic modulators than for the single modulator of the conventional linear polarisation approach. Lower voltages can be modulated more rapidly than higher voltages, which enables faster nanostructure writing times. This is generally beneficial for fabricating optical elements using the methods disclosed herein, but is particularly relevant in the context of encoding data into optical data storage media, where fast data recordal times are highly desirable.

FIG. 12 shows a flow chart of steps in an example of a method as disclosed herein. In a first step S1 a substrate of transparent material is provided. In a second step S2, femtosecond pulses of laser light are generated, for application to the substrate in order to induce nanopores for the provision of a birefringence effect, as described above. In a third step S3, the laser pulses are provided with an elliptical polarisation state, for example by passing them through a universal retarder or other polarising apparatus, where the elliptical polarisation has an ellipticity and an azimuth. The ellipticity and the azimuth are set with regard to a desired retardance and slow axis orientation of the birefringence to be formed. In a fourth step S4, the elliptically polarised laser pulses are focused and applied or delivered to a region or volume inside the substrate, corresponding to the focal point of the focused laser light. The laser pulses create a nanostructure or nanostructures in the volume of the substrate. In a fifth step S5, if it is desired to create further nanostructures in the substrate at other locations, the ellipticity and/or the azimuth of the elliptical polarisation state can be modified, altered or changed, having regard to a desired retardance and slow axis orientation for a next nanostructure. If the retardance and slow axis orientation are required to be the same as for the nanostructure created in step S4, there is no need for the modification. Then, in step S6, laser pulses are applied to the region designated for the next nanostructure, where the pulses have the modified ellipticity and/or azimuth if these parameters have been modified in step S5. Steps S5 and S6 can be repeated until all regions of interest within the substrate that require nanostructures have received suitably configured elliptically polarised laser pulses. Multiple regions or volumes can be written so as to be contiguous, providing a continuous nanostructural modification throughout all or part of the material of the substrate. Alternatively, the regions or volumes can be spaced apart, perhaps in a regularly periodic array, which is relevant for applications such as the encoding of data in an array of voxels inside a substrate. In such a case, each iteration of step S5 is executed by selecting the ellipticity and/or the azimuth in order to encode data in the next nanostructure of the next region via the retardance and slow axis orientation. Alternatively, the elliptical polarisation parameters can be selected in order to create an optical element with a birefringence pattern suitable for a desired optical application such as the provision of optical devices such as waveplates.

The bulk material of the substrate used to form an optical element using the described elliptical polarisation writing process is a transparent material, meaning that it has a significant transmission for at least some wavelengths across the spectrum from ultraviolet to the near-infrared (roughly 200 nm to 2500 nm). It should have a high transparency at the wavelength used for the elliptically polarised laser pulses, and also for the intended light beams to be used with the finished optical element (for reading stored optical data, or to be optically transformed or manipulated by the element). Usefully, the material may be an amorphous glass material. For example, it may be silica (silicon dioxide, SiO₂), including fused silica. The silica or other glass material might be doped with other materials to modify its optical properties. Examples of doped or multicomponent glasses may include materials such as Al₂O₃, B₂O₃, alkaline earth oxides and Na₂/K₂O but other elements and compounds may be used; the disclosure is not limited in this regard. Other materials for the optical element may be any material able to support the laser induced nanostructures, including materials in which nanogratings such as a type II modification or a type X modification have previously been demonstrated. These include multicomponent glasses, GeO₂ glass, porous glass, aerogel glass, silicon and silicon materials, semiconductor materials, lithium niobate and other lithium oxide compounds. Other materials are not excluded, however. In the case of doped silica or other materials, the parameters of the laser pulses may require selection to take account of the physical properties of the material, in particular the bandgap and the thermal properties. The nanostructures are formed so as to be embedded within the volume of the material of the optical element. They can be formed in a single layer, with a thickness of the layer being in a range of about 50 μm to about 500 μm. Control of the laser pulse parameters and the focusing can create a plurality of layers at different depths in the element (i.e. at different positions along the length of the propagation direction of the pulses). As an example, the optical element may have a thickness in this direction of about 3 mm, although thicker and thinner dimensions can of course be used as convenient.

As mentioned above, the pulse energy may be selected in conjunction with factors including the number of pulses and the numerical aperture of the focusing to provide an appropriate amount of optical energy to create the nanostructure. For example, values of pulse energy in the range of 0.8 to 1.5 μJ or 0.8 to 2 μJ per pulse may be appropriate. Alternative pulse energies may be appropriate in other circumstances, depending on the wavelength of the laser beam and the numerical aperture, since these parameters affect the energy density and the interaction of the beam with the material. For example, the pulse energy might be in the range of 0.5 to 2 μJ, or 0.6 to 2 μJ, or 0.7 to 2 μJ, or 0.9 to 2 μJ, or 1 to 2 μJ, or 1.5 to 2 μJ, or 0.5 to 1.5 μJ, or 0.6 to 1.5 μJ, or 0.7 to 1.5 μJ, or 0.9 to 1.5 μJ, or 1 to 1.5 μJ. In some circumstances, the pulse energy may be at least 0.5 μJ, or at least 0.6 μJ, or at least 0.7 μJ, or at least 0.8 μJ, or at least at least 0.9 μJ or at least 1.0 μJ, or at least 1.1 μJ, or at least 1.2 μJ, or at least 1.3 μJ, or at least 1.4 μJ, or at least 1.5 μJ, and may be no greater than 0.8 μJ, or no greater than 0.9 μJ, or no greater than 1.0 μJ, or no greater than 1.1 μJ, or no greater than 1.2 μJ, or no greater than 1.3 μJ, or no greater than 1.4 μJ, or no greater than 1.5 μJ, or no greater than 1.6 μJ, or no greater than 1.7 μJ, or no greater than 1.8 μJ, or no greater than 1.9 μJ, or no greater than 2.0 μJ, or no greater than 2.2 μJ or no greater than 2.5 μJ. Considering pulse energy in relation to numerical aperture (suitable values for which are described in more detail below), larger pulse energies may be selected in combination with lower numerical apertures. For relatively large numerical apertures, the pulse energy can be reduced, and might for example be taken as low as 0.05 μJ. Hence, the pulse energy might be in the range of 0.05 μJ to 0.5 μJ. Other ranges that may be useful include 0.1 μJ to 0.5 μJ, 0.2 μJ to 0.5 μJ, 0.3 μJ to 0.5 μJ, 0.4 μJ to 0.5 μJ, 0.05 μJ to 0.6 μJ, 0.05 μJ to 0.7 μJ, 0.05 μJ to 0.8 μJ, 0.05 μJ to 0.9 μJ, 0.05 μJ to 1.0 μJ, 0.05 μJ to 1.5 μJ and 0.05 μJ to 2.0 μJ, for example.

The pulse energies noted above have been found to be useful in conjunction with pulse durations in the range of 300 to 700 fs in particular, and also in the range of 500 to 900 fs, although other pulse energies may be used with this pulse duration range if appropriate. With appropriate selection of numerical aperture of the focusing arrangement, other pulse durations might be relevant. For example, the pulse duration may be in the range of 300 to 900 fs In other cases, the pulse duration may be in the range of 300 to 400 fs, 300 to 500 fs, 300 to 600 fs, 300 to 700 fs, 300 to 800 fs, 400 to 500 fs, 400 to 600 fs, 400 to 700 fs, 400 to 800 fs, 400 to 900 fs, 500 to 600 fs, 500 to 700 fs, 500 to 800 fs, 500 to 900 fs, 600 to 700 fs, 600 to 800 fs, 600 to 900 fs, 700 to 800 fs, 700 to 900 fs, or 800 to 900 fs. Pulses shorter than 300 fs or longer than 900 fs may be suitable in particular circumstances. For example the pulse duration may be as short as 100 fs or 200 fs, or as long as 1000 fs, so that the duration is chosen to be in a range with a lower limit of 100 fs or 200 fs, and an upper limit of 300 fs, or 400 fs, or 500 fs, or 600 fs, or 700 fs, or 800 fs, or 900 fs, or 1000 fs.

The wavelength of the laser beam may be at or around 1030 nm, such as within the range of 1000 nm to 1060 nm. Other wavelengths may also be used, including shorter wavelengths such as at or around 515 nm and at or around 343 nm. Hence, the wavelength might be chosen in the range of 340 nm to 1100 nm. Other smaller ranges may be appropriate depending on the other operating parameters, such as in the range of 300 nm to 1000 nm, 400 nm to 1000 nm, 500 nm to 1000 nm, 600 nm to 1000 nm, 700 nm to 1000 nm, 800 nm to 1000 nm, 900 nm to 1000 nm, 300 nm to 900 nm, 400 nm to 900 nm, 500 nm to 900 nm, 600 nm to 900 nm, 700 nm to 900 nm, 800 nm to 900 nm, 300 nm to 800 nm, 400 nm to 800 nm, 500 nm to 800 nm, 600 nm to 800 nm, 700 nm to 800 nm, 300 nm to 700 nm, 400 nm to 700 nm, 500 nm to 700 nm, 600 nm to 700 nm, 300 nm to 600 nm, 400 nm to 600 nm, 500 nm to 600 nm, 300 nm to 500 nm, 400 nm to 500 nm or 300 nm to 400 nm, or any of 300 nm, 400 nm, 500 nm, 600 nm, 700 nm, 800 nm, 900 nm or 1000 nm to 1060 nm or 1100 nm or 1200 nm. Alternatively, the ranges may extend down to 200 nm in some examples. Longer wavelengths may also be used, so that the upper end of the above-listed ranges might instead be 1300 nm, or 1400 nm, or 1500 nm, or 1600 nm, or 1700 nm, or 1800 nm, or 1900 nm, or 2000 nm, or 2100 nm, or 2200 nm, or 2300 nm, or 2400 nm, or 2500 nm. Overall, therefore, the wavelength might lie in the range of 200 nm to 2500 nm. Any suitable laser source can be used to generate the writing beam, but a Ti:sapphire laser, operating to generate a femtosecond output tunable within the wavelength range of 650 nm to 1100 nm may be used. Also, higher harmonics of this near-infrared range could be used. Another example laser is an ytterbium-doped potassium gadolinium tungstate regenerative amplified laser, mode locked to provide pulses in the femtosecond domain. Other lasers and optical sources operable in the visible and/or near-infrared spectral range could also be used.

The numerical aperture of the focusing arrangement may for example be about 0.16, or a value near to 0.16, such as between 0.14 and 0.18, or between 0.12 and 0.20, or between 0.10 and 0.22, or may be within a larger range such as 0.16 to 0.4. Lower numerical apertures might also be used, including as low as about 0.05. Therefore, in some example the numerical aperture might be between 0.05 and 0.4, or 0.05 and 0.3, or 0.05 and 0.2, or 0.05 and 0.15, or 0.05 and 0.1, or 0.05 and 0.09, or 0.05 and 0.08, or 0.05 and 0.07, or 0.05 and 0.06.

Hence, a variety of ranges for all the various laser parameters might be chosen. As will be appreciated, multiple parameters can be adjusted to achieve a selected level of energy delivery to the substrate material, and the skilled person would expect to be able explore the parameters across wide ranges to produce the selected level. This increases the flexibility of the described method; it is not constrained to a small selection of operating parameters, and successful results may be achieved within large ranges, so parameters can be chosen with regard to convenience and available apparatus, for example.

These various parameters have particular relevance for the writing of Type X nanostructures, but may also be used for the writing of Type II nanostructures if an appropriate level of optical energy is delivered, as described above with regard to FIG. 1.

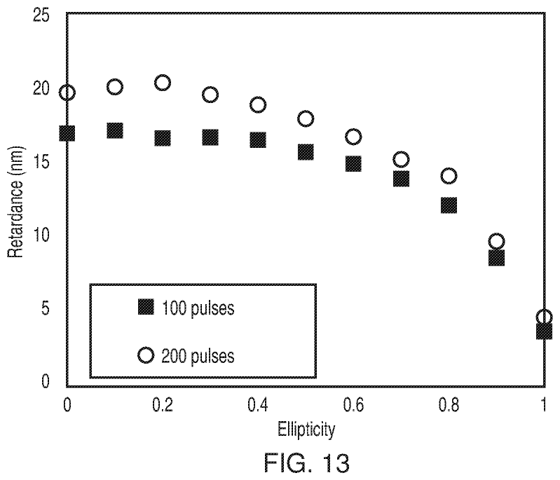

FIG. 13 shows a graph of the dependence of retardance on ellipticity as determined by experiment for the formation of Type II nanogratings. It is analogous to the corresponding graph for Type X nanopores shown in FIG. 7. A selection of nanostructures were written using ellipticity values over the full range of 0 to 1, using either 100 pulses in total (shown on the graph by solid squares) or 200 pulses in total (shown on the graph by open circles). The individual pulse energy was 160 nJ (so that a total energy of either 16000 nJ (16 μJ) or 32000 nJ (32 μJ) was delivered), at a pulse repetition rate of 500 kHz and a wavelength of 1030 nm. The pulses were focused into the substrate with a 0.65 numerical aperture focusing arrangement. The retardance was measured for each nanostructure.

As can be seen, a significant variation in retardance is achieved by varying the ellipticity, similar to the results that can be achieved for Type X modifications. As would be expected, a larger amount of delivered energy creates a larger retardance. The shape of the curve is somewhat different from the Type X data, in that there is a general decrease in retardance over the ellipticity range of 0 to 1, so that the peak retardance appears at or below e=0.2 rather than at e=0.5 for Type X. This may suggest that in order to access the full retardance range for a given writing configuration, the ellipticity should be varied between 0 and 1 rather than between 0.5 and 1. However, the increase in retardance below an ellipticity of 0.5 is not great so that the bulk of the available retardance range can still be accessed between ellipticities of 0.5 and 1, allowing the significant advantage of smaller driving voltages (and voltage ranges) for an electro-optic modulator-based polarising apparatus to be relevant for Type II writing as for Type X writing. Hence, for Type II writing, the same ellipticity ranges as for Type X may be found useful: 0<e<1.0, or 0<e≤1.0, or 0.5≤e≤1.0, or 0.5≤e<1.0, or in other examples a range of 0.2≤e≤1 might be preferred to access all retardance values.

Note that the retardance for an ellipticity of 0.5 is around 5% smaller than the retardance available for linearly polarised light (e=0), corresponding to conventional writing techniques. However, this minor reduction is trivial compared with the benefit of lower driving voltages noted above.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in the future.

### REFERENCES

[1] P G Kazansky, H Inouye, T Mitsuyu, K Miura, J Qiu, K Hirao and F Starrost, Phys. Rev. Lett., vol. 82, 2199-2102, 1999
[2] J Zhang, M Gecevičius, M Beresna, P G Kazansky, Phys. Rev. Lett., vol. 112(3), 33901, 2014
[3] E Bricchi, B G Klappauf, P G Kazansky, Opt. Lett., vol. 29, 119-201, 2004.
[4] S S Fedotov, A G Okhrimchuk, A S Lipatiev, A A Stepko, K I Piyanzina, G Y Shakhgildyan, M Y Presniakov, I S Glebov, S V Lotarev, V N Sigaev, Opt. Lett., vol. 43, 851, 2018
[5] WO 2015/150566
[6] Y Shimotsuma, P Kazansky, J Qui and K Hirao, Phys Rev. Lett. vol. 91, 247405 (2003)
[7] M Beresna, M Gecevicius, M Lancry, B Poumellec and PG Kazansky, Appl. Phys. Lett. vol. 103, 131903 (2013)
[8] C Hnatovskya, R S Taylor, P P Rajeev, E Simova, V R Bhardwaj, D M Rayner and P B Corkum, Appl. Phys. Lett. vol. 87, 014104 (2005)
[9] GB 1802497.6

1. A method of fabricating an optical element comprising:
providing a substrate of a transparent material; and
applying one or more focused femtosecond pulses of laser light with an elliptical polarisation to a volume within the substrate to create at least one nanostructure in the volume.

2. A method according to claim 1, in which the pulses of laser light are applied such that the nanostructure comprises a random distribution of nanopores in the volume.

3. A method according to claim 2, in which the elliptical polarisation has an ellipticity e in the range of 0<e≤1, and the nanopores have an oblate spheroidal shape or a substantially spherical shape.

4. A method according to claim 2, in which the elliptical polarisation has an ellipticity e in the range of 0<e<1, and the nanopores have an oblate spheroidal shape.

5. A method according to claim 2, in which the elliptical polarisation has an ellipticity e in the range of 0.5≤e<1, and the nanopores have an oblate spheroidal shape.

6. A method according to claim 1, in which the pulses of laser light are applied such that the nanostructure comprises a periodic nanograting.

7. A method according to claim 6, in which the elliptical polarisation has an ellipticity e in the range of 0<e≤1.

8. A method according to claim 6, in which the elliptical polarisation has an ellipticity e in the range of 0<e<1.

9. A method according to claim 6, in which the elliptical polarisation has an ellipticity e in the range of 0.5≤e≤1.

10. A method according to claim 6, in which the elliptical polarisation has an ellipticity e in the range of 0.2≤e≤1.

11. A method according to claim 1, further comprising selecting an ellipticity of the elliptical polarisation to create a nanostructure that provides a particular birefringence retardance value in the volume.

12. A method according to claim 1, further comprising selecting an orientation of the major axis of the elliptical polarisation to create a nanostructure that provides a particular birefringence slow axis orientation in the volume.

13. A method according to claim 2, comprising
selecting an ellipticity and an orientation of the major axis of the elliptical polarisation to create nanopores that provide a particular birefringence retardance value and slow axis orientation in the volume, and further comprising, after applying the pulses to the volume,
for each of one or more further volumes within the substrate, selecting an ellipticity and an orientation of the major axis of the elliptical polarisation to create nanopores for providing a particular birefringence retardance value and slow axis orientation in the further volume within the substrate, and applying one or more focused femtosecond pulses of the laser light to the further volume to create nanopores in the further volume.

14. A method according to claim 13, in which the volume and the one or more further volumes comprise a plurality of spaced-apart volumes within the substrate.

15. A method according to claim 14, in which the optical element is a multidimensional optical storage element, and each of the plurality of volumes comprises a voxel, wherein selecting the ellipticity and the orientation of the major axis of the elliptical polarisation for each of the plurality of volumes comprises selecting the ellipticity and the orientation of the major axis of the polarisation in order to encode data via the birefringence retardance value and the slow axis orientation provided by the nanopores in that volume.

16. A method according to claim 1, in which the optical element is configured to manipulate incident light by a geometrical phase effect enabled by birefringence provided by the at least one nanostructure.

17. A method according to claim 1, comprising providing the femtosecond pulses of laser light with a circular polarisation before passing the femtosecond pulses through a polarising apparatus configurable to set the ellipticity and the orientation of the major axis of the elliptical polarisation to selected values.

18. A method according to claim 17, in which the polarising apparatus comprises a first optical modulator with a first variable modulator retardance along a first axis, and a second optical modulator with a second variable modulator retardance along a second axis arranged at 45° to the first axis.

19. A method according to claim 18, comprising varying the first variable modulator retardance and the second variable modulator retardance between −λ/4 and +λ/4, where λ is the wavelength of the laser light, in order to select an ellipticity of the elliptical polarisation between 0 and 1, and an orientation of the major axis of the elliptical polarisation between 0° and 180°.

20. A method according to claim 18, comprising varying the first variable modulator retardance and the second variable modulator retardance between −λ/10 and +λ/10, where λ is the wavelength of the laser light, in order to select an ellipticity of the elliptical polarisation between 0.5 and 1, and an orientation of the major axis of the elliptical polarisation between 0° and 180°.

21. A method according to claim 1, in which the substrate of transparent material comprises undoped or doped silica glass.

22. An optical element fabricated according to a method of claim 1.
